(19) United States
(12) Patent Application Publication
(10) Pub. No.: US 2013/0273224 A1
(43) Pub. Date: Oct. 17, 2013

(54) Alcohol Beverage and Spirits Nosing, Tasting, Drinking, and Sampling Vessel, Procedure or Method for Using Same, and a Process to Separate Ethanol Vapors from Sampling Vapors Prior to Nosing

(71) Applicants: George Manska, Las Vegas, NV (US); Christine Crnek, Henderson, NV (US)

(72) Inventors: George Manska, Las Vegas, NV (US); Christine Crnek, Henderson, NV (US)

(21) Appl. No.: 13/487,255

(22) Filed: Jun. 4, 2012

Related U.S. Application Data
(60) Provisional application No. 61/501,559, filed on Jun. 27, 2011.

(51) Int. Cl. A47G 19/22; B01D 1/30

(52) U.S. Cl. CPC A47G 19/2205; B01D 1/30
USPC 426/493; 220/675; 220/592.17; 220/376; 220/608

(57) ABSTRACT

This application is for a device and article of manufacture for the purpose of drinking, tasting, sampling, and nosing and evaluating alcohol beverages without alcohol nose burn and numbing; a procedure or method to manipulate said vapors for the same purpose; and a process to separate and dissipate ethanol vapors to accomplish the same purpose.

The device is one embodiment of a vessel which collects vapors in a chamber with curved sides and large surface area to promote evaporation, which chamber's top opening orifice concentrates same vapors prior to passing into an expansion chamber releasing and dissipating fast moving ethanol prior to nosing, providing improved aroma detection and enhancing nosing, tasting, and sampling experiences for all spirits, wines and liqueurs, distilled, fermented, and fortified.

### FEDERALLY SPONSORED RESEARCH

This application is not under contract with or by a United States Government Agency. No government assistance, grant funding or Federal sponsored research was used.

### BACKGROUND

This application refers to: a vessel for sampling, tasting, nosing, and evaluating beverages containing ethanol; a procedure or method for sampling, tasting, nosing, and evaluating beverages containing ethanol; and a process and means to selectively separate the vapors and aromas of ethanol from the other aromas of liquids and beverages for the purpose of drinking, tasting, sampling, smelling, and nosing beverages or liquids containing ethanol alcohol.

### Prior Art

| | | Classifi- | | |
|---|---|---|---|---|
| Type | Pat. No. | cations | Patent Date | Patentee |
| U.S. | 6,189,715 B1 | 215/374 | Feb. 20, 2001 | Dubois |
| Pat. No. | | | | |
| U.S. | 2,143,027 | N/A | Jan. 10, 1939 | Perry |
| Pat. No. | | | | |
| Design | D575,108 S | D7/523; | Aug. 19, 2008 | Musso et al. |
| | | D7/524; | | |
| | | D7/509 | | |
| Design | D569,189 S | D7/523; | May 20, 2008 | Kehrein et al. |
| | | D7/509 | | |
| Design | D555,429 S | D7/523; | Nov. 20, 2007 | Lipson |
| | | D7/524 | | |
| Design | D548,528 S | D7/523; | Aug. 14, 2007 | Cha et al. |
| | | D7/509 | | |
| Design | D544,306 S | D7/524; | Jun. 12, 2007 | Festa |
| | | D7/300.1 | | |
| Design | D543,786 S | D7/524 | Jun. 5, 2007 | Walsh |
| Design | D535,558 S | D9/440 | Jan. 23, 2007 | Kehoe et al. |
| Design | D515,927 | D9/503; | Feb. 28, 2006 | Smay et al. |
| | | D7/615 | | |
| Design | D495,210 | D7/524; | Aug. 31, 2004 | Rosow |
| | | D7/537 | | |
| Design | D459,156 S | D7/524; | Jun. 25, 2002 | Davidson |
| | | D7/523; | | |
| | | D7/509 | | |
| Design | D156,921 S | N/A | Jan. 17, 1950 | Sloan |

### Discussion of Prior Art

Source of Ethanol in Beverages: Ethanol is a component of all alcohol beverages and is present in wines and spirits as a by-product of distillation and fermentation, or by fortification or addition of ethanol to an existing beverage.

Physiological Effects of Ethanol: The pungent odor of ethanol obscures many subtle odorant aromas of distilled, fermented, fortified, and barrel aged alcohol beverages and spirits. Ethanol is neuropathological and can cause damage and eventual neuron death to olfactory neuron receptors from overexposure. Ethanol causes an unpleasant nose burn sensation, as well as a numbing and anesthesia of olfactory neuron receptors. Hyposmia is a reduced ability to smell and detect odors, and increases with age. Removing olfactory ethanol becomes a factor in olfactory appreciation of alcohol beverages in aging tasters, samplers, nosers and evaluators who have experienced a natural loss of olfactory perception since birth.

Tasting and Nosing as Evaluation Tools: Tasting and nosing evaluations of alcohol beverage samples are the common method of quantifying flavor for personal enjoyment, pricing, marketing, demand, collectability, production quality control, and competitive judgment. Flavor is the interaction of smell and taste. Although neural processing of odors and aromas is not yet fully understood, it is generally accepted that five basic tongue tastes, sweet, sour, salty, bitter, and amame, work in concert with a thousand or more discernible aromas to form flavor perception. The potential of nosing and tasting to evaluate flavor are severely limited by strong, overpowering, numbing ethanol.

Evaporation: Evaporation is a result of molecular collision within a liquid or beverage imparting energy to molecules to break through liquid surface tension. Continual evaporation creates vapor pressure which drives odorants upward with a natural tendency to expand. Evaporated odorants have various molecular weights and shapes, and move at different velocities. Ethanol is one of the lightest and most prevalent odorants in an alcohol beverage, and evaporates faster than most odorant molecules.

The Role of Evaporation in Tasting and Nosing: Evaporation is the natural, physical process which presents odorants and aromas to the olfactory neuron receptors for evaluation. Evaporation increases with temperature, mixing or agitation or swirling, and with increased evaporative surface area. Vessel shape is an aid to enhancing and increasing evaporation if said shape facilitates controlled hand warming or temperature control, swirling by mixing and agitation, and provides adequate evaporation area.

Vessel Height Effect on Aroma Sample Quality: Ethanol is among the lightest and simplest molecular shapes of odorants in an alcohol beverage. Many other odorants have heavy molecular weights, larger molecular size, and complex molecular shapes which hinder upward movement to reach the rims of tall vessels. Heavier odorants fall back into the liquid escaping olfactory evaluation. Vessel height becomes a factor in providing representational odorant sample characteristics. Vessels with rim location higher than 4.5 centimeters above the evaporative surface of the beverage present an odorant sample over weighted with ethanol. Ethanol as a percentage of all odorants increases at higher rim heights, as heavier molecules return to the liquid. Odorant samples are further over weight with ethanol when coupled to narrow, columnar, chimney type vessel shapes which embody small evaporation surface areas.

### Background of the Vessel

Shape: Existing vessel shape accomplishes two functions; to hold the beverage to be sampled, and to provide a method to position the human mouth to receive the beverage as it leaves the vessel. Nosers, samplers, and tasters select existing vessels subjectively to present olfactory and gustatory characteristics of the alcohol beverage for evaluation with little or no consideration of evaporative and molecular science.

Proliferation of Shapes: Many similar vessel shapes exist due to marketing attempts to persuade shape identification to a particular beverage source, geographic area, or grape varietal. Most common shapes relate to eye appeal and attractive style with some ergonomic considerations such as length of stem and bowl size, but with little or no consideration of physical properties of the beverage odorant sample.

Patentability of Commonly Used Vessels: The emphasis on vessel design eye appeal has led to heavy utilization of the design patent process. Few vessel patents make claims of utility, and common marketing practices present many unsubstantiated claims as to utility. Future study and application of science can lead to more vessel utility patents.

State of Technology Vessel Design—Convergent Rim: Convergent rim is the most common vessel design and describes a vessel with or without stem and foot, consisting of a bowl to hold the beverage, and sides that converge to a smaller opening area than the widest area of the bowl, concentrating odorants in a convenient location for olfactory detection prior to escape into the atmosphere. Ethanol aromas which obscure and dominate subtler odorants and aromas are also concentrated into the same location.

A snifter is a convergent rim vessel with a large bowl to facilitate evaporation with proportionally large beverage evaporation surface area. Large bowl size permits incoming air to dilute but not dissipate ethanol. Ethanol aroma becomes evident and detectable as vapor pressure causes odorants to rise to the vessel rim. Snifters allow the nose to enter the vessel top opening to sample all diluted odorants and aromas including ethanol.

During beverage transfer to the palate, convergent rim vessels concentrate the pour into a fine stream which generally falls onto the forward portion of the tongue, resulting in less taste bud coverage at initial contact on the palate, and a narrow flavor perception.

State of Technology Vessel Design—Vertical Sides: Straight, vertical or nearly vertical side vessels provide the same or nearly the same cross sectional area at the rim plane as at the evaporative surface plane. Such vessel design relies on incoming air to dilute but not dissipate ethanol, operating similar to said snifter without a concentration feature.

State of Technology Vessel Design—Divergent Sides: Divergent vessel sides permit air to mix with the odorants of the beverage and dilute the smell of the alcohol as well as other odorants. Divergent side vessels are unstable for drinking and spill easily from the sides of the mouth when tilted, due to divergent rim geometry. The common Martini glass is an example of a divergent side vessel. Divergent side vessels also have a propensity to spill during handling, due to their divergent sides presenting a gradual ramp for beverage movement unless steady handling is employed. Divergent side vessels are not a frequent choice for nosing and sampling due to handling instabilities and lack of functional aromatic features for nosing and tasting.

During beverage transfer to the palate, divergent rim vessels expand the pour from a fine stream into a sheet waterfall which falls across the entire tongue width, resulting in greater taste bud coverage at initial contact and broadening flavor perception.

Vessel utility patents exist, however, none are utility patented as an ALCOHOL BEVERAGE AND SPIRITS NOSING, TASTING, DRINKING AND SAMPLING VESSEL, or nearly similar designation, use, or function and most vessels are design patented.

U.S. Pat. No. 6,189,715 B1, a utility patent by Dubois, Snifter for Alcoholic Beverages Such as Brandy, Spirits and Liquors, granted Feb. 20, 2001 alleviates some nose burn from ethanol by diluting odorants with a large volume of air in the evaporation chamber. Major drawbacks of the snifter are dilution but not dissipation, and low recommended fill line restricting evaporative surface to a small area compared to larger diameters of the evaporation chamber. The recommended fill line for one embodiment also limits the amount of spirit for a single serving. These parameters slightly reduce ethanol, as well as all other odorants. The inventor recommends sipping the beverage through a straw which is unacceptable to many alcohol beverage drinkers.

Two design patented vessels are commonly used and marketed as tasting vessels; specifically, D543,786 S by Davidson, granted Jun. 5, 2007, and D459,156 S by Walsh, granted Jun. 25, 2002. Said references have limited surface area to promote evaporation by swirling, both have narrow opening areas which concentrate all odorants, including overpowering ethanol obscuring subtle odorant aromas, both embody rim heights higher than the effective limit for providing accurate representational odorant nosing samples, and both provide narrow pour stream to the palate resulting in narrow flavor profile, although the Walsh reference is slightly improved over the Davidson reference.

Other prior art references are design patents which embody design shape similarity to the application, and for which no functional or utility claims have been made and would not meet aforementioned criteria for an adequate nosing and sampling vessel.

Tasting, nosing, and sampling, is the evaluation process of collectors, connoisseurs, judges, aficionados, and consumers, and is the basis for industry demand, pricing, production, and marketing. Evaluation tool choice is determined from existing vessels marketed as tasting and evaluation vessels without verifiable effectiveness, functional claims or design consideration of the physiology of evaporation and odorant properties.

### Background of the Procedure or Method

Procedures Developed to Reduce Ethanol Effects—Vessel Proximity to the Nose: Physical procedures and techniques have been developed to reduce ethanol effects on the olfactory system for particular existing vessel shapes.

One procedure used with tall rim and convergent rim vessels is to hold the vessel about 10-30 cm from the nose and waft the vapors toward the nose with successive hand waves while slowly inhaling to gradually acclimate olfactory sensors to ethanol prior to nosing.

Another procedure involves placing a beverage liquid sample into the oral cavity prior to olfactory sampling and holding while saliva mixes with the beverage, raising beverage surface tension providing some hydrogen bonding to ethanol to slow evaporation. The mixture is then swallowed and air drawn in to the mouth over the palate to pick up the odorant sample through the pharyngeal passage to the olfactory neuron receptors.

Using another procedure for convergent rim shapes, the nose is slowly brought closer to the glass in each of three successive approaches as slow and deliberate inhalation takes place to gradually acclimate the olfactory sensors to ethanol.

Procedures Developed to Reduce Ethanol Effects—Adding Elements to Slow Evaporation: Adding water or ice cubes shuts down evaporation by raising surface tension. Adding chilled “stones”, marbles, or ceramic chips lowers temperature and slows evaporation, decreasing odorant aroma detection. Evaporation of ethanol and all odorants is slowed when adding water, ice, or chilled stones.

Procedures Developed to Reduce Ethanol Effects—Temperature Control: Hand warming elevates beverage temperature to increase evaporation of odorants, and is dependent upon vessel shape, since many vessels fail to provide sufficient hand heat transfer area and are awkward to hold. The large, globular foot on the vessel described in U.S. Patent D543,7865 by Davidson, granted Jun. 5, 2007, serves as a heat sink, soaking up hand heat prior to beverage warming, increasing time required to raise temperature to improve evaporation. The short stemmed D459,1565 by Walsh, granted Jun. 25, 2002, forces the user to hold the vessel on stem and bowl simultaneously, providing very little area for hand heat transfer and affecting visual evaluation due to skin color refraction.

Procedures Developed to Reduce Ethanol Effects—Swirling: Swirling is a procedure to mix and agitate the beverage to enhance aeration and evaporation. Swirling wets the inside of the vessel sides and increases dynamic evaporation surface area.

Procedures Developed to Reduce Ethanol Effects—Breathing: Opening the mouth when inhaling decreases nasal suction and allows outside air to enter the oral cavity and mix with air inside the olfactory chamber through the pharyngeal passage, reducing ethanol nose burn. The favored approach when smelling food, flowers, and perfume, is to inhale through the nose with closed mouth to ensure detection of all subtle aromas and odorants. Inhaling alcohol spirits in small opening, convergent rim glasses with mouth closed will cause alcohol nasal burn, anesthetic numbing, and destroy olfactory ability to smell subtle aromas and odorants.

Many procedure or method patents exist, however there are none specifically utility patented as a PROCEDURE OR METHOD FOR USING AN ALCOHOL BEVERAGE AND SPIRITS NOSING, TASTING, DRINKING AND SAMPLING VESSEL, or nearly similar designation, use, or function.

Common procedures have evolved from existing, inadequate tasting, nosing, and sampling vessels based on traditional convergent rim theory, or attractive appearance. Said procedures reflect attempts to improve performance of the existing vessel. No known vessels eliminate stop-gap procedures and functionally improve tasting, sampling, and nosing using a specific employment procedure.

### Background of the Process

Processes formulated to utilize physical differentials between odorants and aromas, or to manipulate the physical process of evaporation to promote separation of ethanol are unknown. Known processes are limited to two lines of reasoning: first, to collect all odorants close to the nasal passage openings with a convergent rim to hinder aroma and odorant escape prior to odorant sampling, relying on the olfactory organ to select and differentiate ethanol from other collected aromas; second, to provide a convergent rim with large bowl and evaporation area such as a snifter, to dilute ethanol vapors by allowing outside air to mix with the collected odorants, diminishing but not dissipating ethanol aromas prior to nosing, and simultaneously diluting other odorants.

Many process patents exist, none utility patented as a PROCESS TO SEPARATE ETHANOL VAPORS FROM SAMPLING VAPORS PRIOR TO NOSING, or nearly similar designation, use, or function.

### SUMMARY

The vessel utilizes physical shape to separate ethanol alcohol from other characteristic beverage aromas and odorants resulting in a detectable, distinctive, discernible, memorable olfactory and gustatory sample unhindered by the strong scent of ethanol.

The vessel also can be used to sample, blend, and evaluate perfumes, eau de toilettes, colognes, fragrances, scents and oils without strong overpowering ethanol.

The procedure or method for employing the vessel further assures dissipation of ethanol aromas and provides improved, discernible, and intense odorant samples for evaluation.

The process of manipulating odorants by concentration then expansion through an orifice by vapor pressure separates the ethanol alcohol aromas from other odorant aromas.

### DRAWINGS—FIGURES

FIG. 1 depicts an elevation view of the first embodiment of the vessel

FIG. 2 depicts a bottom view of the first embodiment of the vessel.

FIG. 3 depicts a top view of the first embodiment of the vessel

FIG. 4 depicts a section view of the elevation of the first embodiment of the vessel

FIG. 5 depicts a section view of the vessel showing element reference numbers

FIG. 6 depicts a perspective view of the vessel showing a typical vessel bowl fill and a generalized location and proximity of the sweet spot.

FIG. 7 depicts a section view of the vessel showing a typical vessel bowl fill and a generalized location and proximity of the sweet spot.

FIG. 8 depicts a perspective view of the vessel showing the location of the evaporation chamber.

FIG. 9 depicts a section view of the vessel showing the location of the evaporation chamber.

FIG. 10 depicts a perspective view of the vessel showing the location of the evaporative expansion chamber.

FIG. 11 depicts a section view of the vessel showing the location of the evaporative expansion chamber.

FIG. 12 depicts a top view of an embodiment of the vessel with stem and foot.

FIG. 13 depicts a sectional view of the side view of an embodiment of the vessel with stem and foot.

FIG. 14 depicts a side view of an embodiment of the vessel with stem and foot.

FIG. 15 depicts a bottom view of an embodiment of the vessel with stem and foot

FIG. 16 depicts the vessel in a perspective view.

FIG. 17 depicts an embodiment of the vessel with an optional cup handle.

FIG. 18 depicts the vessel with an optional watch glass cover embodiment and optional ornamental cover embodiment.

FIG. 19 depicts the vessel in a double-wall insulated embodiment.

FIG. 20 depicts an embodiment of the vessel with an interior bottom hump, punt, or kick to promote aeration during the fill pour and add additional evaporative surface area.

FIG. 21 depicts an embodiment of the vessel with ridges to enhance aeration.

FIG. 22 depicts a section of the rim of FIG. 21 with ridges added to the inside surface of the expansion chamber to enhance aeration while drinking.

FIG. 23 depicts an alternate section to FIG. 22 to with bumps added to the inside surface of the expansion chamber to enhance aeration.

### GLOSSARY OF TERMS

Ethanol refers herein to common edible alcohol prominent in many liquid beverages, common chemical symbol C₂H₅ (OH). Sometimes referred to as ethyl alcohol, grain alcohol, drinking alcohol, and pure alcohol, ethanol and alcohol are used interchangeably.

Evaporation chamber or collection chamber is herein defined as the spatial volume directly above the beverage liquid surface area into which evaporated odorants are collected before being forced out by vapor pressure. The collection chamber is bounded by divergent vessel sides, beverage surface area, and the orifice.

Evaporation equilibrium is achieved when an open ended vessel is covered and allowed to stand until the evaporated vapors are at a maximum density, and as many evaporated molecules are arising from the liquid surface as are returning to the liquid surface. When equilibrium is achieved, the noser removes the cover, quickly placing the beverage in the proximity of the nose to sample the odorants at maximum density.

Evaporative expansion chamber is herein defined as the spatial volume directly above the vessel orifice into which the evaporated odorants pass after they cross the orifice plane, and is bounded by divergent rim sides, the orifice, and rim plane, beyond which rim plane ethanol aromas dissipate into the atmosphere.

Evaporative surface plane is herein defined as a two dimensional plane which contains the static evaporative surface area, and is parallel to the rim and orifice planes.

Evaporative surface area is herein defined in the vessel at rest static state as the beverage surface area, from which odorants evaporate, located in the evaporative surface plane; and defined in the dynamic state which occurs during vessel motion or swirling, as the evaporative area of the static state plus wetted surface area of the convergent sides.

Liquid sample is herein defined as the liquid being nosed, tasted, sampled, or evaluated.

Neck is herein defined as the outside of the vessel at the junction of the convergent sides of the evaporative collection chamber and the divergent sides of the evaporative expansion chamber in the plane of the internal orifice and provides a convenient grip.

Noser is herein defined as one who performs nosing as described, or gas chromatography or mass spectrometry analyzer, olfactometer, or similar apparatus.

Nosing is herein defined as the process of passing one's nose over the open end of a vessel containing a liquid while inhaling through the nostrils to present an olfactory sample to the olfactory sensors for detection, identification, or classification of odors, or aromas emanating or evaporating from said liquid, or the use of a gas chromatography or mass spectrometry analyzer or similar apparatus to accomplish said purpose.

Odorant is herein defined as a chemical compound which activates the olfactory system, defined by a specific odor or aroma. Odorant applies to liquid or aromatic form, or both.

Odorant sample is herein defined as evaporated odorant vapors.

Orifice is herein defined as the opening which connects the collection chamber with the expansion chamber, and is a restriction, being smaller in cross sectional area than the evaporative surface, which serves to concentrate odorants prior to expansion, located in the orifice plane.

Orifice plane is herein defined as a two dimensional plane which contains the area herein designated as orifice and defined by the contiguous junction between convergent sides of the collection chamber and divergent sides of the expansion chamber. The orifice plane is parallel to the rim and evaporative surface planes.

Rim lip is herein defined as the rim edge, or mouth or top opening of the vessel and is a circular area located in the rim plane. In addition, said rim lip is a convenient locator for the human mouth to aid in positioning the nose into the sweet spot for sampling.

Rim plane is herein defined as a two dimensional plane which contains the rim lip as the top terminus of the vessel divergent sides, and is parallel to the evaporative surface and the orifice planes.

Sample can refer to the liquid sample or the odorant sample, which is a vapor sample.

Sampling is herein defined as the process of nosing and tasting, and refers to the gustatory and olfactory evaluation of the beverage to determine flavor and aromas of odorants by the human olfactory system, gas chromatography or mass spectrometry analyzer, olfactometer, or similar device or procedure. Sampling, tasting and nosing are interchangeable except in the case of perfumes and scents, which are not gustatory.

Spirits are herein defined as beverages and concoctions which contain common edible ethanol alcohol from distillation or fermentation, including but not limited to whiskeys, rum, vodka, gin, tequila, liqueurs, brandy, Cognac, Armagnac, eau de vie, fortified and dessert wines, infused liquors, aperitifs, sake, and wines. Spirits also include perfumes, eau de toilettes, and scented aromas and oils which are olfactory evaluated.

Sweet Spot is herein defined as the spatial volume above the orifice in the proximity of the rim plane, from which lighter, fast moving ethanol molecules have diffused leaving slower, heavier molecule odorants to nose. The size, volume and proximity of the sweet spot depend upon odorant characteristics.

Swirling is herein defined as a physical method of mixing and agitating a beverage within a vessel by rotating continuously, deliberately, and evenly to promote continuous liquid motion and expose the beverage to atmosphere to enhance odorant evaporation.

Tasting is herein defined as a combination of olfactory nosing and odorant sampling, and transfer of the liquid sample from the vessel to the oral cavity to detect characteristics of taste (sweet, salty, sour, bitter, and amame). During tasting, odorants escape into the olfactory cavity via the pharyngeal passage, and the perceptions of smell and taste coordinate in the brain, forming a single, inseparable flavor. Tasting is olfactory and gustatory, and used interchangeably with nosing and sampling.

Whiskey is herein used interchangeably with whisky, regardless of spelling, geographical or regional preference.

### DRAWINGS—REFERENCE NUMERALS (FIG. 5)

31 evaporation chamber volume, or evaporation collection chamber, bounded by 32, 33, and 34
32 liquid or evaporative surface area
33 convergent vessel sides
34 orifice
35 expansion chamber volume bounded by 34, 36, and 37
36 divergent vessel sides
37 rim opening area
38 rim lip
39 proximity of sweet spot volume
40 neck

### Detailed Description of the First Embodiment of the Vessel

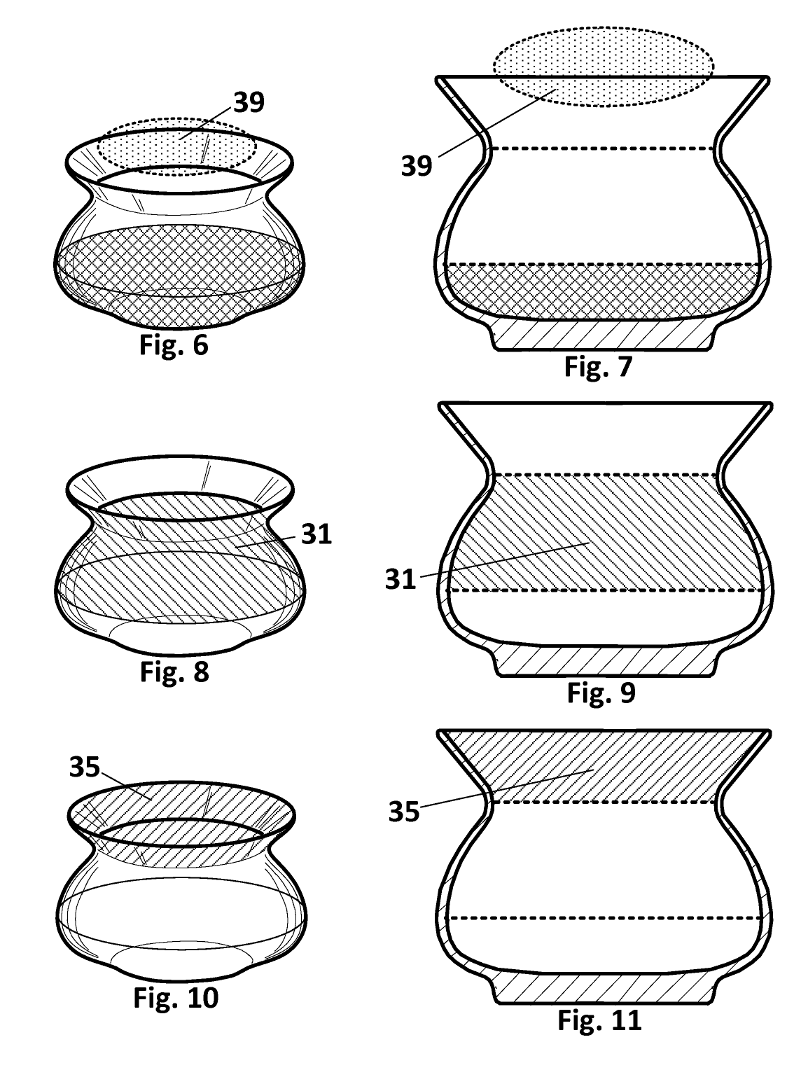

Construction of the vessel is herein described as a bowl (FIGS. 5, 6, 7), to which is attached evaporation collection chamber volume 31 (FIGS. 5, 8, 9), which collection chamber is bounded on the bottom by liquid surface area 32, bounded on the sides by convergent vessel sides 33 attached at their lower extremity to the bowl at liquid surface area 32, and bounded at the top by orifice 34. Expansion chamber volume 35 (FIGS. 5, 10, 11) is bounded on the bottom by orifice 34, located directly above said evaporation collection chamber 31, and bounded on the sides by divergent vessel sides 36, attached at their lower extremity to convergent vessel sides 33 at orifice 34, and bounded on the top by rim opening area 37, at which divergent vessel sides 36 terminate at their upper extremity to form rim lip 38.

The vessel herein described, separates and dissipates ethanol prior to nosing and olfactory evaluation and resolves said nosing problems in four distinct stages.

The evaporative stage utilizes liquid and static evaporative surface area 32 and an additional dynamic evaporation area on the wetted inside of the outwardly curved vessel sides to promote evaporation while swirling. The vessel shape exposes lower vessel bowl area in contact with the beverage to hand warming by cradling vessel bowl in the palm, enhancing evaporation of odorants and aromas to desired intensity. Gripping the vessel at neck 40 between thumb and forefinger provides cooling and prevents hand warming.

The collection stage is realized within evaporative chamber 31. Vapor pressure drives aromas and odorants upward in a natural tendency to expand. All evaporated odorants and aromas move randomly within evaporation collection chamber 31.

The concentration stage utilizes convergent sides 33 to direct odorants and aromas to orifice 34, smaller than evaporative surface 32 which concentrates all odorants and promotes molecular collision, increased vapor density, increased vapor pressure, and higher molecular velocities at orifice 34.

The expansion stage takes place in expansion chamber 35 with divergent sides 36 allowing greater degree of molecular movement. As vapor pressure forces odorants through orifice 34, lighter, faster moving ethanol molecules disperse rapidly over the edges of rim lip 38 into the atmosphere, leaving heavier, slower, odorous molecules in proximity of a sweet spot 39 for olfactory sampling. Rim lip 38 conveniently positions the nasal passage openings in proximity of the sweet spot by placing human lips on rim lip 38. Rim lip 38 geometry aids in preventing nasal passage insertion below orifice 34 into evaporative chamber volume 31, which will expose olfactory sensors to ethanol.

During tasting, the divergent rim lip 38 of the vessel delivers the pour to the palate in a wide sheet waterfall shape, broadening the flavor profile over prior art references by Walsh and Davidson by increasing taste bud exposure.

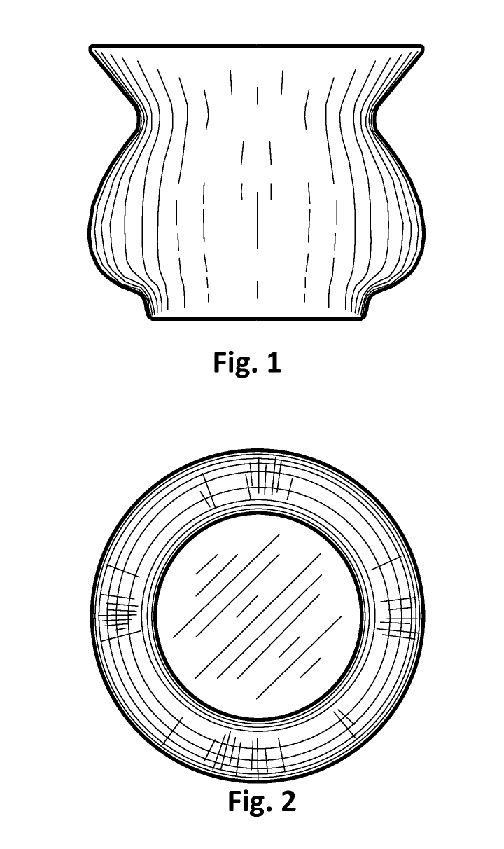

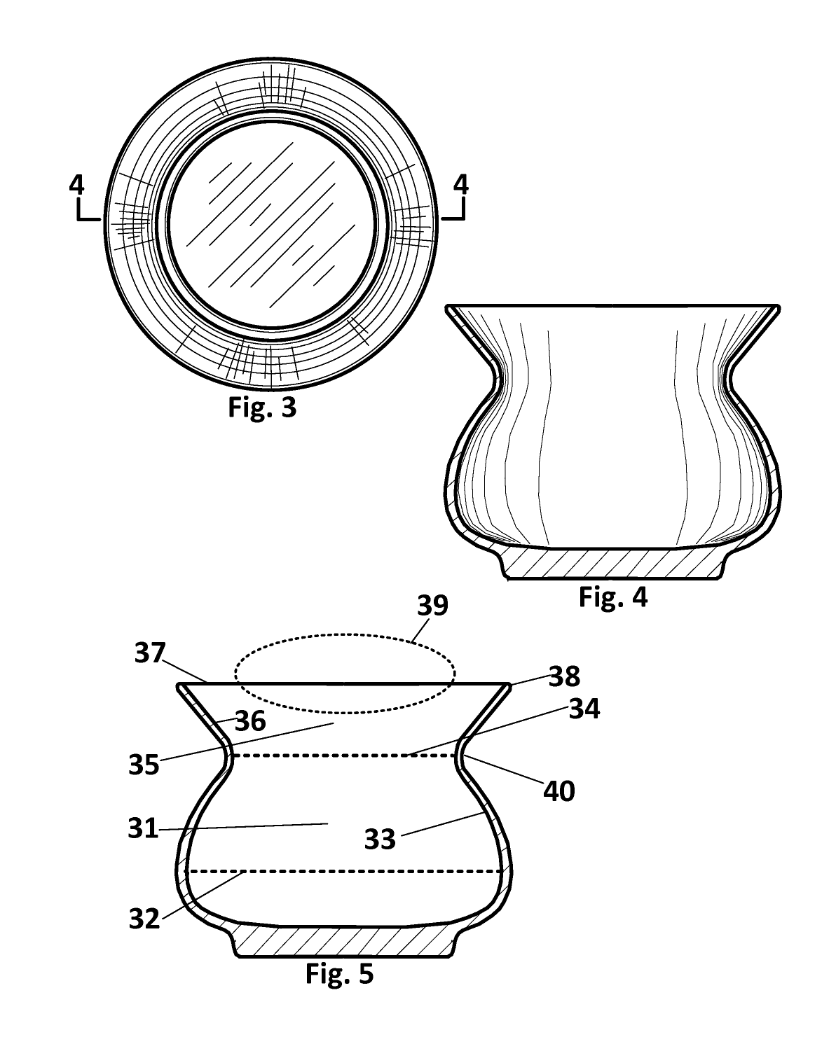

### Operation of the First Embodiment of the Vessel—FIGS. 1-5

Preferred use of the vessel is to add beverage to the vessel up to the maximum horizontal diameter of the bowl at evaporative surface plane 32 while vessel sits level and upright, swirl slowly and deliberately to wet vessel sides, hold vessel level under the nose with lips touching rim lip 38 of the vessel, and tilt the head forward or backward slightly while inhaling through the nose to determine the best position to maximize olfactory sensing. User should avoid placing the nose into the vessel below orifice plane 34 since that action will result in strong odor of ethanol, numbing the olfactory sensors. Vessel bowl may be hand held to warm to desired temperature to promote evaporation, or held between thumb and forefinger at neck 40 to cool.

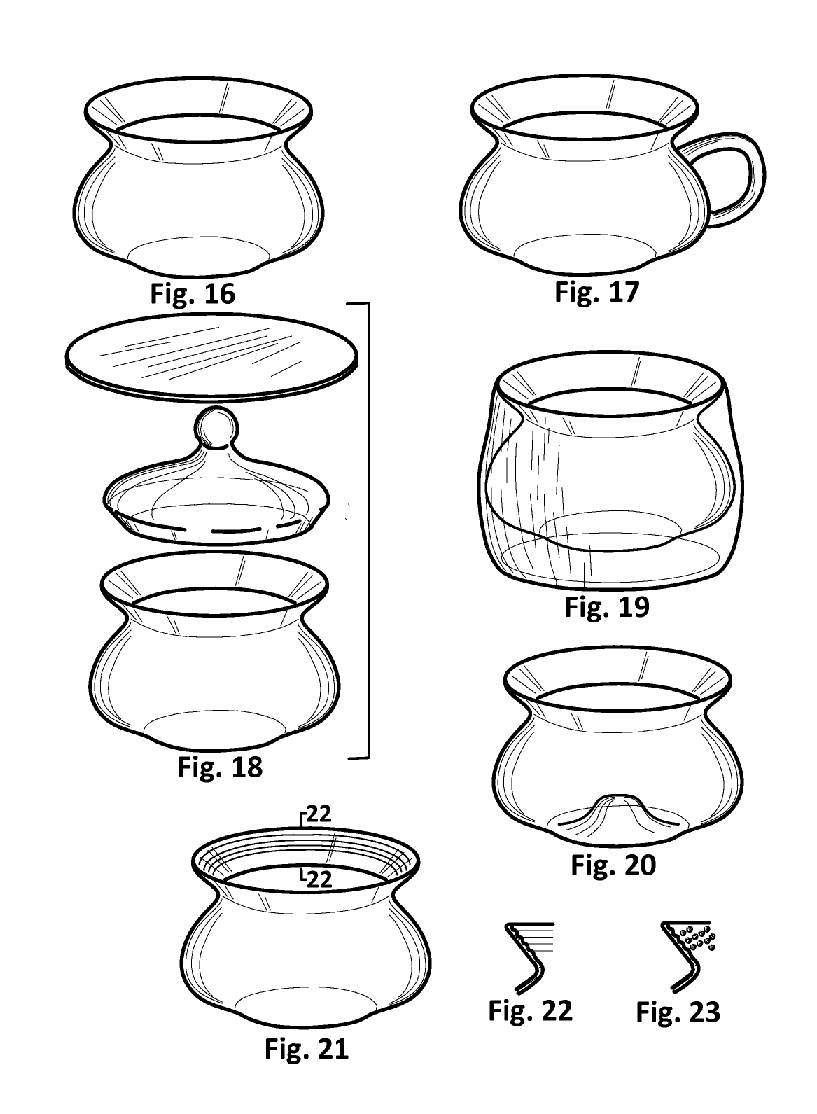

### Manufacture and Materials of the Vessel—FIGS. 1-23

Methods of manufacture include hand-made mouth blowing methods, machine blow molding, machine pressing, casting, turned or lathe spun, ground, hand lamination, or nanotechnology from any material which is safe to use as a drinking vessel. Said materials include but are not limited to glass, crystal, woods, metals, resins, polymers, plastics, graphite fiber, nanotech materials, paper, mineral, rock or stone, clays, porcelains, kaolins, ceramics, concrete or aggregate in any color, texture, or appearance.

### Detailed Description of the Procedure or Method

The procedure herein described, replaces the need for stop-gap procedures and preconditioning techniques which alter the beverage or attempt to precondition the olfactory organ to the presence of ethanol. Said application procedure promotes separation and dissipation of ethanol aroma prior to nosing.

The application procedure is comprised of at least the following: Step 1 in which a sample of alcohol beverage is poured into the bowl at evaporative surface plane 32; step 2 in which vessel is held in the palm of the hand to add hand heat to warm, and alternately held by neck 40 between thumb and forefinger to allow cooling, the combination of said alternate methods controlling liquid temperature and evaporation to the sampler's preferences; step 3 in which swirling increases evaporation and vapor pressure; step 4 in which odorants and aromas are collected in evaporation chamber 31; step 5 in which said odorants are concentrated by convergent sides 33, step 6 in which said odorants are forced by vapor pressure through orifice 34 into expansion chamber 35; step 7; in which lighter ethanol molecules expand outward and separate from remaining odorants and aromas prior to olfactory sampling; step 8, in which placement of human lips on rim lip 38 locates nose in proximity of sweet spot 39; step 9, tilting the head slightly forward or back to adjust nose position to seek proximity of most detectable aromas; and step 10, during transfer to the palate for liquid sampling, rim lip 38 delivers a wide sheet waterfall shape to expose more taste buds at contact and broaden flavor profile.

### Detailed Description of the Process

The process described herein separates and diverts ethanol from other odorants and aromas by collecting, condensing, and concentrating said odorants and aromas utilizing orifice 34 to increase molecular collision frequency and velocities of lighter ethanol molecules forced through said orifice by vapor pressure, to escape during expansion, and separate from heavier aromatic odorants prior to olfactory sampling.

### Advantages of the Vessel, Procedure or Method, and Process

Advantages of one or more aspects of the vessel, the procedure or method, and the process to individual tasters, nosers, samplers, aficionados, collectors, critics, and casual drinkers, are: dissipation of ethanol to provide an improved drinking experience without olfactory desensitization or strong disagreeable ethanol aroma; more detectable, definitive, pleasant, distinctive, discernible, and memorable olfactory and gustatory sample of aromas for tasting and sampling evaluation; more sensitive noses can appreciate drinking spirits without debilitating, neuropathological, disagreeably strong and overpowering ethanol; expanded markets to females, who as a populace generally have more sensitive noses than males; elimination of altering beverages by adding water or ice to reduce alcohol evaporation to make the spirit more approachable, which dilutes the spirit and closes down all evaporation and aroma characteristics; elimination of common altering of beverages by adding chilled stones, marbles or ceramics to reduce alcohol evaporation to make the spirit more approachable, which lowers beverage temperature and closes down evaporation and aroma characteristics; better agreement among judges at competitive awards events without strong ethanol to obscure and mask subtle aromas, a methodical process to maximize dissipation of ethanol and improve the odorant nosing and sampling process. The rim lip delivers a broad initial flavor profile to more taste buds for sampling and evaluation.

One or more aspects of the vessel, procedure and method, and process also provide several benefits to the alcohol beverage industry. Better manufacturing quality control during aging and cellaring by providing accurate, earlier detection of aromas which indicate poor quality; more accurate, advanced information for planning unique blends, additions, and concoctions for future marketing and sales; reduced blending times to reproduce or recreate a unique product edition by improving the blender's judgment without ethanol interference; expanded markets to sensitive noses and women, increasing sales and demand, driving prices and profit margins higher; improved uniformity of evaluation at competitive events, by unmasking subtle aromas for judges and evaluators; added niche and specialty markets for unique product editions with specific aromas; expanded collector markets by presenting and unmasking subtle complex aromas, leading to a better understanding of beverage characteristics. The procedure provides a uniform method for sampling alcohol beverages which improves correlation among samplers, nosers, tasters, judges, and critics within the beverage industry.

### Detailed Description of the Embodiments

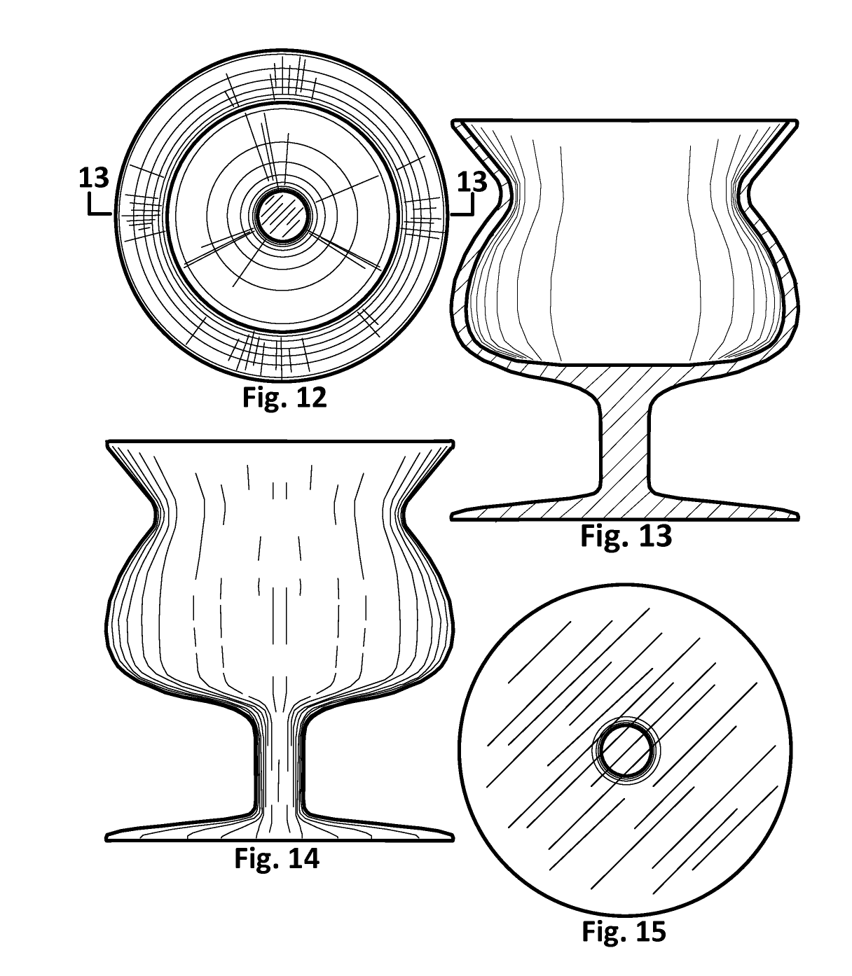

Several embodiments of the vessel have various appendages to improve handling, gripping, and holding, such as stem and foot (FIGS. 12-15), or cup handle (FIG. 17). Similar embodiments include addition of ears, a ladle handle, or a detachable apparatus to surround the vessel with a holding and handling appliance similar to a quaitch.

Other possible embodiments include double vessel walls for insulation (FIG. 19); an ornamental lid (FIG. 18), or an alternate watch glass cover (FIG. 18) to provide vessel closure for reaching evaporative equilibrium prior to nosing.

Other embodiments of the vessel have ridges (FIG. 21, 22), bumps (FIG. 23), grooves, troughs, dams, or cuts either on the inside of the vessel bowl to promote mixing with air while swirling, or on the inside of the divergent rim area to promote mixing with air while sipping, or a combination of both.

Other embodiments utilize surface treatment such as frost etching, ridges, thumb and finger placements to improve grip, or identification or personalization marks, initials, decorations, etching, appliqués, decals, or grinding to individual preference.

Another embodiment utilizes geometry or shape changes to the vessel rim in order to ergonomically accommodate and fit the shape of the human lip more precisely.

Another embodiment has a rough ground or etched surface on the exterior to add and place identifying marks, letters or numerals to denote and identify a particular sample with a marker pen, pencil, crayon, or paint or other such instrument.

### Conclusion, Ramification, Scope

In conclusion, at least one variation of the alcohol beverage and spirits nosing, tasting, drinking and sampling vessel; the procedure or method for using same; and the process to separate ethanol vapors from sampling odorant vapors prior to nosing provides a useful function to individual tasters and nosers, by dissipation of ethanol to improve tasting experience, and set a new level of appreciation for subtle aromatic intricacies of alcohol beverages. Dissipation of ethanol will attract more of the populace with sensitive noses to appreciate drinking spirits without neuropathological, disagreeable ethanol, and expand markets to more women. Dissipation of ethanol will avoid altering the beverage with water, ice, or chilling to reduce ethanol as unnecessary, and permit the beverage to be sampled, nosed, and tasted as produced without ethanol side effects. Dissipation of ethanol will diminish controversy and result in better agreement among judges at competitive awards events without strong ethanol to obscure and mask subtle aromas.

Benefits to the alcohol beverage industry, include improved manufacturing quality control during the aging and cellaring process from earlier detection of aromas which indicate poor quality; advanced information for planning unique blends for future marketing and sales; reduced blending times; expanded markets to sensitive noses and women; increased demand, sales and profit margins; improved evaluation uniformity; added niche markets; expanded collectors markets, leading to a better understanding of alcohol beverages, and providing a better correlation within the industry by standardizing procedures and vessel for nosing and tasting alcohol beverages.

The ramifications are; major changes to perception, marketing and sales of alcohol beverage industry products by increased awareness of aromatic subtleties of these beverages and changing the demand and markets for certain aromatic characteristics.

While the above specification contains multiple specificities, these should not be construed as limitations on the scope, but rather as an exemplification of several of the embodiments thereof. Many other variations of shape within the application are possible. For example, within the scope of the embodiments, many shapes can be tailored and fine-tuned to provide and showcase specific odorants and aromas, while accomplishing the claims of dissipation of ethanol alcohol. Many variations may be applied to the procedure or method of manipulating evaporative vapors. For example, the decision of best pour level and whether to add hand heat or use a cover to obtain evaporation equilibrium are the noser's choice, depending on his own olfactory sensitivity and desire to fine tune the odorant sample. Accordingly, the scope should be determined not by the embodiments illustrated or discussed, but by the appended claims and their legal equivalents.

We claim:

1. A device for drinking, tasting, sampling, smelling, and nosing liquids and beverages containing ethanol alcohol, comprising; a bowl to hold a liquid, and an evaporation chamber volume, further comprising at least a liquid or beverage evaporative surface area, convergent sides connected to the evaporative surface at their lower extremity, and an orifice connected to said convergent sides at their upper extremity; and an expansion chamber, further comprising at least said orifice connected to divergent sides at their lower extremity also contiguous with said convergent sides at said divergent sides lower extremity and, a vessel rim connected to said divergent sides at their upper extremity; and said vessel utilizes evaporative vapor pressure and said elements to collect odorants in said evaporation chamber and further concentrate said odorants and aromas by said convergent sides through said orifice plane into said expansion volume, whereupon ethanol aromas of higher volatility and lower weight, move at higher velocities and separate rapidly from other odorants and aromas and dissipate over a rim lip into the atmosphere, diminishing ethanol presence prior to nosing, and said rim lip provides a location for the human mouth and therefore the sampler's nasal passage openings in proximity of the sweet spot resulting in a distinctive, discernible, memorable olfactory and gustatory sample unhindered by overpowering scent of ethanol.

2. The device of claim 1 further comprised of an alternate method of holding by the human hand of an optional stem and foot (FIGS. 12-15), or a cup handle (FIG. 17), or protrusion, appendage, handle, or ears, added to bowl, rim, sides or bottom of the vessel to provide greater vessel handling control.

3. The device of claim 1 further comprised of an ornamental lid or watch glass cover to present an added benefit of evaporation equilibrium if preferred (FIG. 18).

4. The device of claim 1 further comprised of an outside or double wall of any shape to insulate the device from outside heating or cooling, with or without a vacuum or inert gas or liquid isolated between the walls or to improve vessel handling (FIG. 19).

5. The device of claim 1 further comprised of the embodiment or embodiments of a physical characteristic or characteristics including a hump, punt, or kick (FIG. 20), on the inside bottom for the purpose of creating fluid motion to aid in aeration while pouring, swirling or tasting, or ridges (FIGS. 21, 22), or bumps (FIG. 23), or etched or molded lines, or valleys, or troughs, or dams, or cuts, or relief patterns on the rim or bowl inside to aid aeration when pouring, swirling or tasting.

6. The device of claim 1 constructed from any material suitable for a drinking vessel.

7. The device of claim 1 further comprised of decoration or coloration to enhance or change visual appeal, or identify, including but not limited to color co-ordination, or personalization, engraving, grinding, cutting, or etching to individual preference, including modification for sample identification, or adding decals, transfers, or markings.

8. A procedure or method, and means to condition and manipulate the evaporated vapors and aromas of liquids and beverages containing alcohol for the purpose of drinking, tasting, sampling, smelling, and nosing, comprised of steps; step 1 comprising of at least a sample of alcohol beverage poured into the vessel bowl, step 2 comprised of at least swirling the beverage to increase evaporation and vapor pressure, step 3 comprising of at least collection of odorants and aromas in the evaporative chamber, step 4 comprised of at least concentration of said odorants by convergent sides, step 5 comprised of at least the passage of vapors through the orifice plane into the expansion chamber, step 6 comprised of at least expansion outward, separation, and dissipation of volatile and light ethanol molecules from remaining odorants and aromas prior to olfactory sampling, step 7 in which the human nasal passage opening or openings are placed in the proximity of the sweet spot, and step 8 in which odorants are sampled by inhaling and said stepped procedure provides a distinctive, discernible, memorable olfactory and taste sample unhindered by the overpowering scent of ethanol alcohol.

9. The procedure or method and means of claim 8 comprising an additional step further comprised of at least raising beverage temperature to increase evaporation by holding the vessel in the palm of the hand to add warming hand heat, and alternately holding by the neck around the orifice between thumb and forefinger to allow the vessel to cool, the combination of which controls temperature and evaporation to the sampler's preference, and repeating step 8 intermittently to check sample suitability for olfactory satisfaction.

10. The procedure or method and means of claim 8 comprising an additional step further comprised of placing a cover, lid, or watch glass over the opening of the vessel to obtain evaporation equilibrium prior to resampling by step 8 to check sample suitability for olfactory satisfaction.

11. The procedure or method and means of claim 8 comprising an additional step further comprised of at least tilting the head slightly forward or back to adjust the nose position into proximity of the most detectable aromas, and placement of the human lips on the rim lip to locate the human nose in proximity of the sweet spot.

12. A process or means of selectively separating the ethanol from remaining aromas and odorants of liquids and beverages containing ethanol for the purpose of drinking, tasting, sampling, smelling, and nosing, comprising; an evaporation chamber volume, further comprising at least, an evaporative surface, convergent sides, connected to said evaporative surface at their lower extremity and an orifice, connected to said convergent sides at their upper extremity, and an expansion chamber volume, further comprising at least, said orifice, connected to divergent sides at their lower extremity, contiguous with said convergent sides at said divergent sides lower extremity and vessel rim connected to said divergent sides at their upper extremity; and said method utilizes evaporative vapor pressure and said elements to collect odorants and aromas in an evaporation chamber, and further concentrate said odorants and aromas by convergent sides through the orifice into the expansion chamber, whereupon the ethanol vapors and aromas being of higher volatility, lower weight, and higher velocities than other aromas, separate rapidly from other odorants and aromas and dissipate over the rim lip, diminishing ethanol prior to nosing, and said rim lip provides a fixed location of the human mouth and therefore the nostrils of the person sampling the liquid into the sweet spot, to provide a detectable, distinctive, discernible, memorable olfactory and gustatory sample.

13. The process or method of claim 12 in which the vessel is appropriately positioned and adjusted to locate the human nose in proximity of the sweet spot and under the nostrils, to provide a detectable, distinctive, discernible, memorable olfactory and gustatory sample without placing the human lips on the vessel rim lip.
